(19) United States
(12) Patent Application Publication
(10) Pub. No.: US 2016/0088932 A1
(43) Pub. Date: Mar. 31, 2016

(54) Laptop ventilated computer table

(71) Applicant: Frederick David Clark, Altamonte Springs, FL (US)

(72) Inventor: Frederick David Clark, Altamonte Springs, FL (US)

(21) Appl. No.: 14/250,296

(22) Filed: Sep. 30, 2014

(51) Int. Cl. A47B 23/04; G06F 1/20; A47B 23/00

(52) U.S. Cl. CPC A47B 23/04; A47B 23/001; A47B 23/002; G06F 1/203; A47B 2023/049

(57) ABSTRACT

Laptop ventilated table invention is designed to allow air to flow freely around computer leaving

Cooling van and air vent unobstructed while providing secure and convenient support for laptop use

Laptop ventilated table is lightweight and is constructed for ultimate comfort.

The continuous airflow of the design keeps heat away from the body when used on the lap due to solid

Bottom design and complete front and side ventilation.

The laptop table can be custom designed to meet the various sizes of laptop dimensions and ports

My Laptop ventilated table invention is designed to allow air to flow freely around computer leaving cooling fan and air vent unobstructed, while providing secure and convenient support for Laptop use. The laptop table is designed with rails in front and back and no rails on sides to allow for free and unobstructed computer ports. Rails also provide secure placement of Laptop.

Laptop ventilated table is lightweight and on the bottom of the bottom board the edges and corners are rounded for comfort on your lap. The two rails on the top board are also rounded and finished to provide a comfortable place for your wrists while using the laptop.

The continuous airflow of the design keeps heat away from the body when used on the lap due to solid bottom design and complete front and side ventilation. Top and Bottom of table is secured by 8 pegs which measure 13/16 of an inch.

The laptop table can be custom designed to meet the various sizes of laptop dimensions and ports.

Prototype is constructed of painted wood and can also be manufactured in other materials such as plastics or metals as applicable.

Dimensions are as follows for a 15.6 inch laptop

Length 14¾ inch

Width 10¾ inch

Top opening Length 11¾ inch

Width 7¼ inch

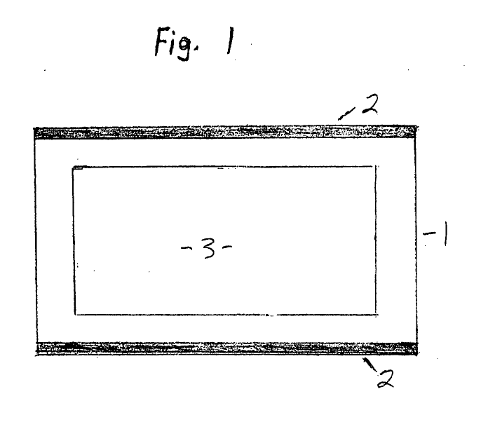

Description Laptop Aerial View FIG. 1

Constructed of Project Panel Grade Board dimensions 10¾ by 14¾

Topped by general purpose molding ¼ by ¾ as lip on the 14¾ sides

by crazy glue and mounted to solid bottom board with 8 Wooden dowels ⅜ in diameter

Part 1 is top board with ventilated cutoff

Part 2 is molding

Part 3 is cutout opening

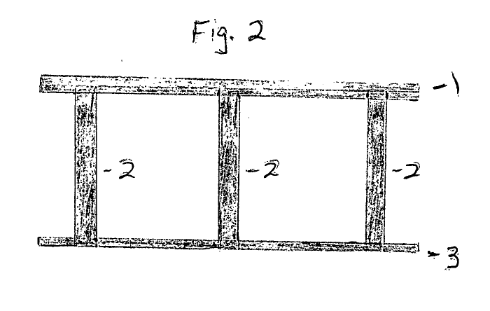

Description FIG. 2

Front View showing dowels supporting solid bottom board to top open cutout with molding attached on top board as shown as part 1

dowels shown as part 2

Bottom solid board is part 3

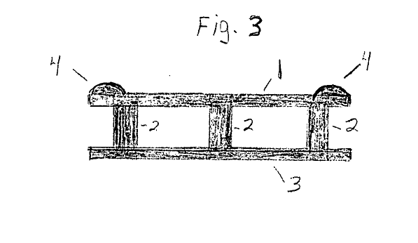

Description FIG. 3

table side view showing the 10% side of laptop table and supporting dowels

Top board is part 1

Supporting dowels are part 2

Solid bottom board is part 3

Moldings are part 4

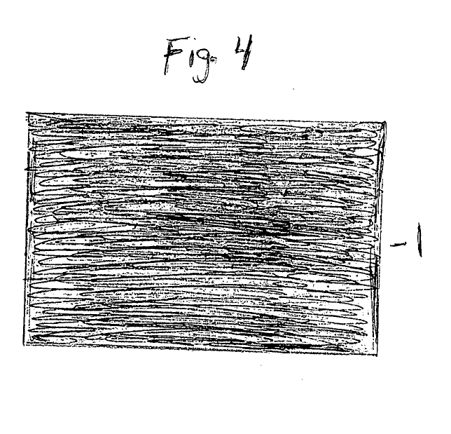

FIG. 4 description

Solid bottom board Par 1

1- Value of laptop ventilated table invention is to allow for comfort laptop use as well as the elimination of heat around the laptop.

2- A well ventilated laptop table will increase the longevity of the laptop while allowing heat to be kept away from your body as well as placement of wrists due to design to ensure hours of comfortable computing.

3- The ventilated laptop table keeps heat generated by laptop computer from transferring to any finished surface potentially damaging that surface.
